(19) United States
(12) Patent Application Publication
(10) Pub. No.: US 2020/0213233 A1
(43) Pub. Date: Jul. 2, 2020

(54) BALANCING LOAD

(71) Applicant: Hangzhou DPtech Technologies Co., Ltd., Zhejiang Province (CN)

(72) Inventors: Le WANG, Zhejiang (CN); Yanjie SUN, Zhejiang (CN); Jian ZHAN, Zhejiang (CN)

(73) Assignee: Hangzhou DPtech Technologies Co., Ltd., Zhejiang Province (CN)

(21) Appl. No.: 16/724,745

(22) Filed: Dec. 23, 2019

(30) Foreign Application Priority Data
Dec. 27, 2018 (CN) 201811608512.0

(51) Int. Cl. H04L 12/803

(52) U.S. Cl. CPC H04L 47/125

(57) ABSTRACT

The present application provides a load balancing system. In an example, the load balancing system includes a client, a first load balancer coupled to the client, a plurality of security forwarding devices whose load sides are coupled to the first load balancer and forwarding sides are coupled to a second load balancer, the second load balancer, and a server coupled with the second load balancer. In the load balancing system, service traffic resources can be accurately allocated to the target security forwarding device selected by the scheduling algorithm, so as to balance load.

### CROSS-REFERENCE TO RELATED APPLICATIONS

The application claims priority to Chinese Patent Application No. 201811608512.0, filed on Dec. 27, 2018, the entire contents of which are hereby incorporated by reference for all purposes.

### TECHNICAL FIELD

The present application relates to the field of network technology, and in particular, to how to balance load.

### BACKGROUND

In order to ensure the safe and stable operation of network, some enterprises and institutions adopt a safety partition protection strategy. In the safety partition protection strategy, according to a function of a network area, the entire network may be divided into two or more security areas. To facilitate management, two or more identical security forwarding devices are deployed between two security network areas, and used as a data transmission path between the two security areas.

### SUMMARY

In view of this, the present application provides a load balancing system and method.

According to a first aspect of the present application, there is provided a load balancing system including a client, a first load balancer coupled to the client, a plurality of security forwarding devices whose load sides are coupled to the first load balancer and forwarding sides are coupled to a second load balancer, the second load balancer, and a server coupled with the second load balancer. The first load balancer is configured to: receive a first access request packet from the client; use a scheduling algorithm to select a target security forwarding device from the plurality of security forwarding devices; when a destination IP address of the first access request packet is the same as an IP address of a load side of the target security forwarding device, rewrite a destination MAC address of the first access request packet with a MAC address of the load side of the target security forwarding device to generate a second access request packet; and send the second access request packet to access to the server through the target security forwarding device.

According to a second aspect of the present application, there is provided a load balancing method applicable to a load balancer. The load balancing method includes: receiving a first access request packet from a client, wherein the load balancer is coupled to forwarding sides of a plurality of security forwarding devices; using a scheduling algorithm to select a target security forwarding device from the plurality of security forwarding devices; when a destination IP address of the first access request packet is the same as an IP address of a load side of the target security forwarding device, rewriting a destination MAC address of the first access request packet with a MAC address of the load side of the target security forwarding device to generate a second access request packet; and sending the second access request packet to access to a server through the target security forwarding device.

According to a third aspect of the present application, there is provided a load balancing method applicable to a target security forwarding device. The load balancing method includes: receiving a second access request packet from a first load balancer, wherein the target security forwarding device is one of a plurality of security forwarding devices and selected by the first load balancer with a scheduling algorithm, the first load balancer is coupled to load sides of the plurality of security forwarding devices, and the second access request packet is generated by rewriting a destination MAC address of a first access request packet from a client with a MAC address of a load side of the target security forwarding device; and constructing a third access request packet according to the second access request packet, wherein a source IP address of the third access request packet is an IP address of a forwarding side of the target security forwarding device, a destination MAC address of the third access request packet is a MAC address of the server; and transmitting the third access request packet to a second load balancer, so that the second load balancer transmits the third access request packet to the server, wherein the second load balancer is coupled to forwarding sides of the plurality of security forwarding devices.

### BRIEF DESCRIPTION OF DRAWINGS

FIG. 1 is a flowchart illustrating a load balancing method performed by a first load balancer according to an example of the present application.

FIG. 2 is a flowchart illustrating a load balancing method performed by a second load balancer according to an example of the present application.

FIG. 3 is a flowchart illustrating a load balancing method performed by a security forwarding device according to an example of the present application.

FIG. 4 is a schematic diagram illustrating an application scenario during the load balancing according to an example of the present application.

FIG. 5 is a flowchart illustrating a load balancing method according to an example of the present application.

FIG. 6 is a schematic diagram illustrating a structure of a first load balancer according to an example of the present application.

FIG. 7 is a block diagram illustrating a load balancing apparatus according to an example of the present application.

FIG. 8 is a schematic structural diagram illustrating a structure of a second load balancer according to an example of the present application.

FIG. 9 is a block diagram illustrating a load balancing apparatus according to an example of the present application.

FIG. 10 is a schematic structural diagram illustrating a structure of a security forwarding device according to an example of the present application.

FIG. 11 is a block diagram illustrating a load balancing apparatus according to an example of the present application.

### DETAILED DESCRIPTION

Examples will be described in detail herein, with the illustrations thereof represented in the drawings. When the following descriptions involve the drawings, like numerals in different drawings refer to identical or similar elements unless otherwise indicated. The embodiments described in the following examples do not represent all embodiments consistent with the present application. Rather, they are merely examples of apparatuses and methods consistent with some aspects of the present application as detailed in the appended claims.

The terms used in the present application are for the purpose of describing particular examples only, and are not intended to limit the present application. Terms determined by “a”, “the” and “said” in their singular forms in the present application and the appended claims are also intended to include plurality, unless clearly indicated otherwise in the context. It should also be understood that the term “and/or” as used herein refers to and includes any and all possible combinations of one or more of the associated listed items.

It is to be understood that, although terms “first,” “second,” “third,” and the like may be used in the present application to describe various information, such information should not be limited to these terms. These terms are only used to distinguish one category of information from another. For example, without departing from the scope of the present application, first information may be referred as second information; and similarly, second information may also be referred as first information. Depending on the context, the word “if” as used herein may be interpreted as “when” or “upon” or “in response to determining”.

In order to ensure the safe and stable operation of network, some enterprises and institutions adopt a safety partition protection strategy. In the safety partition protection strategy, according to a function of a network area, the entire network may be divided into two or more security areas. To facilitate management, two or more identical security forwarding devices are deployed between two security network areas, and used as a data transmission path between the two security areas. The security forwarding device refers to a network protection device, such as an IPS (Intrusion Prevention System), a UTM (Unified Threat Management) or the like.

In some examples, the security forwarding devices are deployed in a master-backup mode or a double-master mode. In the master-backup mode, all connections are established on one security forwarding device, and even in the case of large service traffic, the backup security forwarding device in an idle state causes the waste of resources. In the double-master mode, two identical security forwarding devices have the same IP (Internet Protocol) address of a load side and the same IP address of a forwarding side, and thus when the service traffic is forwarded to the security forwarding devices, the service traffic is randomly allocated to a security forwarding device. Thus, the allocation of the service traffic is uneven. The uneven allocation may cause the load of a single security forwarding device to be too heavy, thereby affecting the processing of services. The load side of the security forwarding device is configured to perform load balancing function and may also be referred to as a front end. The forwarding side of the security forwarding device is configured to perform forwarding process and may also be referred to as a back end.

In some examples, a plurality of identical security forwarding devices are configured between two security network areas. However, since IP addresses of the load sides of identical security forwarding devices are identical and IP addresses of the forwarding sides of identical security forwarding devices are also identical, forwarding service traffic randomly makes each security forwarding device fail to implement evenly processing of the service traffic.

Based on this, to allocate service traffic resources according to a load state of the security forwarding device, the present application provides load balancing methods.

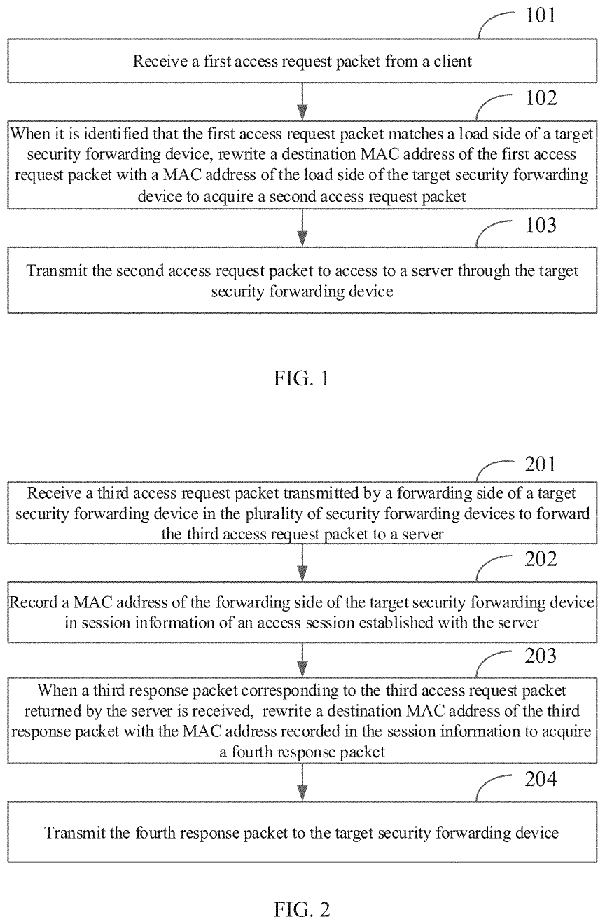

FIG. 1 is a flowchart illustrating a load balancing method performed by a first load balancer according to an example of the present application. As shown in FIG. 1, the method is applied to the first load balancer, and the first load balancer is coupled to load sides of a plurality of security forwarding devices. The method may include the following steps 101-103.

At step 101, a first access request packet transmitted by a client is received.

At step 102, when it is identified that the first access request packet matches a load side of a target security forwarding device, a destination MAC (Media Access Control) address of the first access request packet is rewritten with a MAC address of the load side of the target security forwarding device to acquire a second access request packet, where the target security forwarding device in the plurality of the security forwarding devices is selected by the first load balancer with a scheduling algorithm. The scheduling algorithm includes, but not limited to Round Robin algorithm, Weighted Round Robin algorithm, Least Connection algorithm, Least Connection Slow Start Time algorithm, Weighted Least Connection algorithm, Agent Based Adaptive Balancing algorithm, Fixed Weighted algorithm and Weighted Response algorithm.

In some examples, it is configured that the first load balancer shares the same IP address with the load side of the security forwarding devices, that is, the IP address of the load side of the security forwarding devices is the same as a virtual IP address of the first load balancer, so that when a destination IP address of the first access request packet matches (is the same as) the virtual IP address configured for the first load balancer, it is identified that the first access request packet matches the load side of the target security forwarding device.

At step 103, the second access request packet is transmitted to initiate access to a server through the target security forwarding device.

In some examples, when a first response packet returned by the server through the target security forwarding device is received, a destination MAC address of the first response packet is rewritten with a MAC address of the client to acquire a second response packet, and the second response packet is transmitted to the client. The client may quickly and accurately identify the second response packet according to the destination MAC address of the second response packet. The destination MAC address of the second response packet is the MAC address of the client.

As can be known from the above examples, in the present application, by rewriting the destination MAC address of the first access request packet with the MAC address of the load side of the target security forwarding device, the first load balancer may use the MAC addresses of the load sides of the security forwarding devices to effectively distinguish respective security forwarding devices. In this way, service traffic resources are accurately allocated to the target security forwarding device selected by the scheduling algorithm according to the MAC address of the target security forwarding device, and load balancing of the security forwarding devices are implemented.

FIG. 2 is a flowchart illustrating a load balancing method performed by a second load balancer according to an example of the present application. As shown in FIG. 2, the method is applied to the second load balancer, and the second load balancer is coupled to forwarding sides of the plurality of security forwarding devices. The method may include the following steps 201-204.

At step 201, a third access request packet transmitted by a forwarding side of a target security forwarding device in the plurality of security forwarding devices is received to forward the third access request packet to a server.

At step 202, a MAC address of the forwarding side of the target security forwarding device is recorded in session information of an access session established with the server.

At step 203, when a third response packet corresponding to the third access request packet returned by the server is received, a destination MAC address of the third response packet is rewritten with the MAC address recorded in the session information to acquire a fourth response packet.

In some examples, the second load balancer queries whether there exists a conflicting packet of the third access request packet. A source IP address, a source port number, a destination IP address, and a destination port number of the conflicting packet are consistent with those of the third access request packet. If there exists the conflicting packet of the third access request packet, NAT (Network Address Translation) processing is performed on a source port number of the third access request packet. The NAT-processed third access request packet on which the NAT processing has been performed is transmitted to the server, thereby avoiding problems such as confused connection with the server and abnormal services due to consistent source IP address, source port number, destination IP address, and destination port number.

At step 204, the fourth response packet is transmitted to the target security forwarding device.

As can be known from the above examples, by rewriting the destination MAC address of the third response packet to acquire the fourth response packet, the fourth response packet is transmitted to the target security forwarding device through the second load balancer for processing so as to realize the path consistency of returned traffic, and ensure the load balancing of respective security forwarding devices when processing the response packet. In some examples, if security forwarding device 1 transmits the third access request packet, security forwarding device 1 receives the fourth response packet.

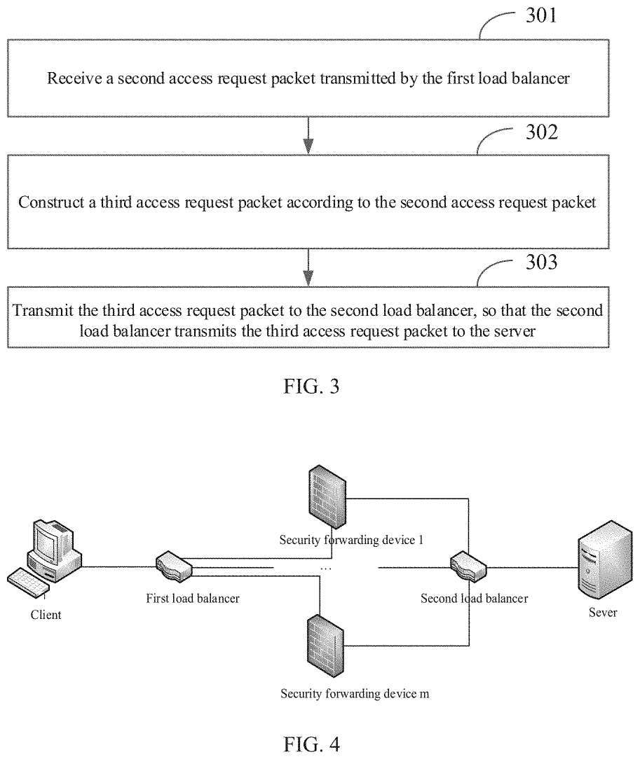

FIG. 3 is a flowchart illustrating a load balancing method performed by a security forwarding device according to an example of the present application. As shown in FIG. 3, the method is applied to the security forwarding device, and the security forwarding device includes a load side and a forwarding side. The load side is coupled to a first load balancer, and the forwarding side is coupled to a second load balancer. The first load balancer and the second load balancer are further coupled to at least one other security forwarding device. The method may include the following steps 301-303.

At step 301, a second access request packet transmitted by the first load balancer is received by the load side of the security forwarding device. The second access request packet is acquired by rewriting, by the first load balancer, a MAC address of a first access request packet transmitted by a client with a MAC address of the load side of the security forwarding device.

At step 302, a third access request packet is constructed according to the second access request packet. A source IP address of the third access request packet is an IP address of the forwarding side of the security forwarding device, which is the same as a virtual IP address of the second load balancer, and a destination MAC address of the third access request packet is a MAC address of a server.

At step 303, the third access request packet is transmitted to the second load balancer, so that the second load balancer transmits the third access request packet to the server.

In some examples, the security forwarding device receives a fourth response packet, where the fourth response packet is acquired by rewriting, by the second load balancer, a destination MAC address of a third response packet returned by the server with a MAC address of the forwarding side of the security forwarding device. The MAC address of the forwarding side is recorded by the second load balancer in session information of an access session established between the second load balancer and the server after receiving the third access request packet.

A first response packet is constructed by the security forwarding device. A destination MAC address of the first response packet is a MAC address of the first load balancer, so that the first load balancer, after rewriting the destination MAC address of the first response packet with a MAC address of the client, forwards the first response packet to the client.

FIG. 4 is a schematic diagram illustrating an application scenario during the load balancing according to an example of the present application. As shown in FIG. 4, it is assumed that there are m security forwarding devices (m is an integer greater than or equal to 2) in the application scenario. The m security forwarding devices are respectively coupled to a first load balancer and a second load balancer, and are respectively marked as; security forwarding device 1 to security forwarding device m.

In this application scenario, the first load balancer receives an access request packet from a client, and forwards the access request packet to one of the m security forwarding devices coupled with the first load balancer. The one of the m security forwarding devices may be referred to as a target security forwarding device. The target security forwarding device is determined by the first load balancer through a scheduling algorithm. The forwarding sides of the m security forwarding devices are coupled to the second load balancer, so that the received access request packet is transmitted to the second load balancer through the forwarding side of the target security forwarding device, and is further transmitted by the second load balancer to a server.

The server responds to the access request packet, that is, the server transmits a response packet corresponding to the access request packet to the second load balancer, and the second load balancer transmits the response packet to the target security forwarding device for processing. The target security forwarding device transmits the response packet to the first load balancer. The response packet is transmitted by the first load balancer to the client.

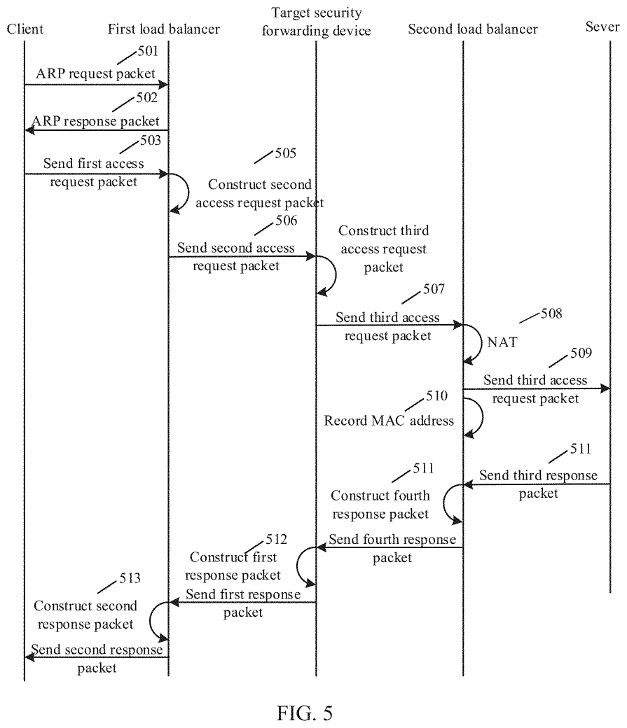

FIG. 5 is a flowchart illustrating a load balancing method according to an example of the present application. The load balancing method is applicable into a load balancing system. The load balancing system includes a client, a first load balancer, m security forwarding devices, a second load balancer and a server. Herein, the client may be a mobile device or a PC, and the server may be a cloud platform server or other virtual server or physical server or the like, and the present application has no specific limitation thereto. The client is coupled to the first load balancer. The first load balancer is coupled to load sides of the m security forwarding devices. The second load balancer is coupled to forwarding sides of the m security forwarding devices. The second load balancer is also connected to the server.

As shown in FIG. 5, the process of the load balancing method may include the following steps 501-513.

At step 501, the first load balancer receives an ARP (Address Resolution Protocol) request packet from the client.

ARP is a TCP/IP (Transmission Control Protocol/Internet Protocol) that acquires a physical address based on an IP address. The client transmits the ARP request packet to acquire a network card physical address name (such as, an Ethernet address or a MAC address) corresponding to a target IP address, so that a packet may be transmitted on a physical link.

At step 502, when a destination IP address of the ARP request packet is the same as a virtual IP address of the first load balancer, the first load balancer transmits an ARP response packet with its own MAC address.

The first load balancer in this example may enable an ARP proxy function, and the virtual IP address of the first load balancer is the same as an IP address of the load side of the target security forwarding device. Therefore, when the destination IP address of the ARP request packet from the client is the same as the virtual IP address of the first load balancer, the first load balancer uses its own MAC address to transmit the ARP request response packet.

At step 503, the client, after receiving the ARP response packet, transmits a first access request packet.

At step 504, the first load balancer receives the first access request packet transmitted by the client, and determines whether a destination IP address of the first access request packet is the same as the virtual IP address of the first load balancer.

At step 505, when the destination IP address of the first access request packet is the same as the virtual IP address of the first load balancer, a destination MAC address in the first access request packet is rewritten with a MAC address of the load side of a target security forwarding device to acquire a second access request packet, where the target security forwarding device in the m security forwarding devices is selected by the first load balancer with a scheduling algorithm.

The first load balancer uses the scheduling algorithm to allocate the first access request packet according to load state of the m security forwarding devices, so that the target security forwarding device that processes a small number of access request packets preferentially processes the first access request packet, and thereby the target security forwarding device with optimal access request packet processing efficiency is invoked according to the load state of the m security forwarding devices for processing the first access request packet. In an example, when the processing efficiency of the target security forwarding device is screened out based on the number of currently received access request packets, the scheduling algorithm used by the first load balancer may also be combined with factors such as the time lengths for which the m security forwarding devices have been used to perform comprehensive judgment on the current processing performance of the m security forwarding devices. For example, for n security forwarding devices in the m security forwarding devices that processes the same number of access request packets, the time length for which each of the n security forwarding devices has been used is further compared, and a security forwarding device in the n security forwarding devices with a shortest used time length is selected to as the target security forwarding device. n is an integer greater than or equal to 2 and less than or equal to m. It is to understand that the shorter time length for which the security forwarding device has been used, the lighter the aging degree of the security forwarding device, and the better the processing performance of the security forwarding device than those security forwarding devices with more serious aging degree. The present application has no limitation to the scheduling algorithm used by the first load balancer to select the target security forwarding device. The scheduling algorithm includes, but not limited to Round Robin algorithm, Weighted Round Robin algorithm, Least Connection algorithm, Least Connection Slow Start Time algorithm, Weighted Least Connection algorithm, Agent Based Adaptive Balancing algorithm, Fixed Weighted algorithm and Weighted Response algorithm.

In an example, partial attribute information of the first access request packet whose the destination IP address is the same as the virtual IP address of the first load balancer is as shown in table 1 below:

TABLE 1

| Source IP | Destination | Source port | Destination | | Destination |
|---|---|---|---|---|---|
| address | IP address | number | port number | Protocol | MAC address |
| 192.168.0.1 | 192.168.0.200 | 6000 | 80 | TCP | 08:00:20:0A:8C:6D |

Where, the source IP address of the first access request packet is an IP address of the client, the destination IP address of the first access request packet is a virtual IP address of the first load balancer, the source port number of the first access request packet is a port number of an application that initiates the first access request packet in the client, and the destination MAC address of the first access request packet is a MAC address of the first load balancer. In an example, the virtual IP address of the first load balancer is the same as the IP address of the load side of the target security forwarding device, and the destination IP address of the first access request packet is also the IP address of the load side of the target security forwarding device.

The first load balancer acquires the MAC address of the load side of the target security forwarding device selected by the scheduling algorithm, and rewrites the destination MAC address of the first access request packet with the acquired MAC address to generate the second access request packet. Correspondingly, partial attribute information of the second access request packet is as shown in table 2 below:

TABLE 2

| Source IP | Destination | Source port | Destination | | Destination |
|---|---|---|---|---|---|
| address | IP address | number | port number | Protocol | MAC address |
| 192.168.0.1 | 192.168.0.200 | 6000 | 80 | TCP | 00:1e:ec:bc:5e:03 |

The source IP address of the second access request packet is the IP address of the client, the destination IP address of the second access request packet is the IP address of the load side of the target security forwarding device, the source port number of the second access request packet is the port number of the application that initiates the first access request packet in the client, and the destination MAC address of the second access request packet is the MAC address of the load side of the target security forwarding device.

At step 506, the target security forwarding device receives the second access request packet, constructs a third access request packet, and transmits the constructed third access request packet to the second load balancer.

In an example, partial attribute information of the third access request packet constructed by the target security forwarding device is as shown in table 3 below:

TABLE 3

| Source IP | Destination | Source port | Destination | | Destination |
|---|---|---|---|---|---|
| address | IP address | number | port number | protocol | MAC address |
| 114.100.20.200 | 114.100.0.165 | 6000 | 80 | TCP | 00:0c:29:01:00:12 |

The source IP address of the third access request packet is an IP address of the forwarding side of the target security forwarding device, the destination IP address of the third access request packet is an IP address of the server, and the destination MAC address of the third access request packet is a MAC address of the server.

At step 507, the second load balancer receives the third access request packet from the target security forwarding device, and when the source IP address of the third access request packet is the same as a virtual IP address of the second load balancer, queries whether the third access request packet is a conflicting packet. If the third access request packet is the conflicting packet, proceed to step 508, otherwise proceed to step 509.

When a plurality of access request packets from the security forwarding devices are transmitted to the same server, the destination IP address, destination port number, and destination MAC address in the attribute information of the plurality of access request packets are identical. Since the IP addresses of the forwarding sides of the respective security forwarding devices are identical, the source IP addresses of the plurality of access request packets from the security forwarding devices are also identical. During the practical use, a plurality of access request packets received by the second load balancer often have the same source port information. Therefore, when the second load balancer forwards the received multiple access request packets with the same source IP addresses, source port numbers, destination IP addresses, destination port numbers, destination MAC addresses to the server, a phenomenon that a plurality of connection information are consistent occurs. The plurality of access request packets with the same attribute information are mutually conflicting packets. The existence of conflicting packets will lead to problems such as confused connection with the server and abnormal services.

At step 508, the second load balancer determines a port number that is currently in an idle state, and performs NAT (Network Address Translation) on a source port number of the third access request packet with the port number that is currently in an idle state.

In an example, the second load balancer queries whether the attribute information of the received third access request packet is unique in a session attribute information list configured to record the received access request packet within a preset time period. If the session attribute information list includes an access request packet having the same attribute information as the third access request packet, the second load balancer determines the port number currently in an idle state, for example, a port number 5000, and rewrites the source port number of the third access request packet with the port number in the idle state, thereby ensuring the uniqueness of the third access request packet to be forwarded to the server. In an example, partial attribute information of the NAT-processed third access request packet on which the NAT processing has been performed may be as shown in Table 4 below.

TABLE 4

| Source IP | Destination | Source port | Destination | | Destination |
|---|---|---|---|---|---|
| address | IP address | number | port number | protocol | MAC address |
| 114.100.20.200 | 114.100.0.165 | 5000 | 80 | TCP | 00:0c:29:01:00:12 |

In table 4, the source IP address of the NAT-processed third access request packet is the IP address of the forwarding side of the target security forwarding device, the destination IP address of the NAT-processed third access request packet is the IP address of the server, and the source port number of the NAT-processed third access request packet is the rewritten port number 5000 in the idle state. The port number in the idle state is used so that the attribute information of the NAT-processed third access request packet on which the NAT processing has been performed is unique in the session attribute information list configured to record the access request packets received by the second load balancer within a preset time period.

At step 509, the second load balancer transmits the third access request packet to the server. If NAT processing is performed on the third access request packet, the second load balancer transmits the NAT-processed third access request packet to the server.

At step 510, the second load balancer records the MAC address of the forwarding side of the target security forwarding device in session information of an access session established with the server.

In an example, the second load balancer transmits the third access request packet to the server and records the MAC address of the forwarding side of the target security forwarding device in session information of the access session established with the server. The MAC address of the forwarding side of the target security forwarding device may be, for example, recorded as 00:1e:ec:bc:5e:04 or in other forms. The present application has no specific limitation to the form of the MAC address of the forwarding side of the target security forwarding device.

At step 511, the second load balancer receives a third response packet corresponding to the third access request packet returned by the server, and sets the MAC address recorded in the access session corresponding to the third access request packet as a destination MAC address in the third response packet to acquire a fourth response packet.

In an example, the second load balancer receives the third response packet returned by the server. The third response packet is a request response packet transmitted by the server with respect to the third access request packet. Partial attribute information of the third response packet is as shown in table 5 below.

TABLE 5

| Source IP | Destination | Source port | Destination | |
|---|---|---|---|---|
| address | IP address | number | port number | protocol |
| 114.100. 0.165 | 114.100.20.200 | 80 | 6000 | TCP |

The source IP address of the third response packet is the IP address of the server, and the destination IP address of the third response packet is the virtual IP address of the second load balancer. Because the virtual IP address of the second load balancer is the same as the IP address of the forwarding side of each security forwarding device coupled with the second load balancer, in order to make the third response packet return response information according to the original transmission path of the third access request packet, the MAC address of the forwarding side of the target security forwarding device recorded in the session information of the access session may be used to set the destination MAC address of the third response packet to acquire a fourth response packet. The setting manner may be manually configured, or be automatically identified and configured by the second load balancer. The present application has no limitation thereto. Partial attribute information of the fourth response packet may be as shown in table 6 below. Where the destination MAC address is the MAC address of the forwarding side of the target security forwarding device.

TABLE 6

| Source IP | Destination | Source port | Destination | | Destination |
|---|---|---|---|---|---|
| address | IP address | number | port number | protocol | MAC address |
| 114.100. 0.165 | 114.100.20.200 | 80 | 6000 | TCP | 00:1e:ec:bc:5e:04 |

At step 512, the target security forwarding device constructs, according to the received fourth response packet, a first response packet, and transmits the first response packet to the first load balancer.

In an example, the constructed first response packet may be as shown in Table 7. Where the destination MAC address of the first response packet is a MAC address of the first load balancer, the source IP address of the first response packet is a IP address of the load side of the target security forwarding device, and the destination IP address of the first response packet is an IP address of the client.

TABLE 7

| Source IP | Destination | Source port | Destination | | Destination |
|---|---|---|---|---|---|
| address | IP address | number | port number | protocol | MAC address |
| 192.168. 0.200 | 192.168. 0.1 | 80 | 6000 | TCP | 08:00:20:0A:8C:6D |

At step 513, when the first load balancer receives the first response packet, the first load balancer queries session information corresponding to the first response packet, the destination MAC address of the first response packet is rewritten with the MAC address acquired from the session information to acquire a second response packet, and transmits the second response packet to the client.

In an example, the first load balancer records a MAC address of a sender of the first access request packet in a session established for the received first access request packet. That is, the first load balancer records the MAC address of the client whose the source IP address is 192.168.0.200. In an example, the recorded MAC address may be 10:8D:85:02:7D:5B or in other forms. The present application has no limitation thereto. When the first response packet is transmitted to the first load balancer, the first load balancer triggers the query on the session information corresponding to the first response packet, acquires the MAC address of the client, and uses the acquired MAC address to rewrite the destination MAC address of the first response packet to acquire the second response packet. Partial attribute information of the acquired second response packet may be as shown in table 8 below.

TABLE 8

| Source IP | Destination | Source port | Destination | | Destination |
|---|---|---|---|---|---|
| address | IP address | number | port number | protocol | MAC address |
| 192.168. 0.200 | 192.168. 0.1 | 80 | 6000 | TCP | 10:8D:85:02:7D:5B |

Where, the source IP address of the second response packet is the virtual IP address of the first load balancer, the destination IP address second response packet is the IP address of the client, and the destination MAC address second response packet is the MAC address of the client.

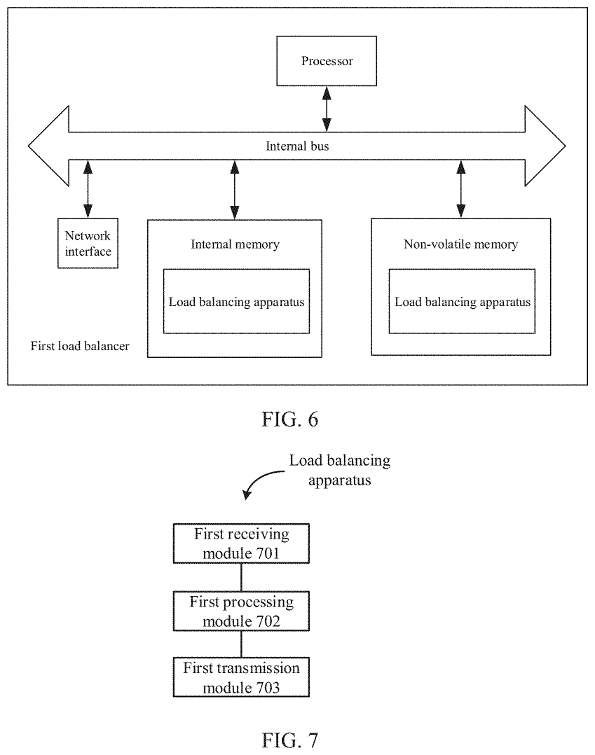

FIG. 6 is a schematic diagram illustrating a structure of a first load balancer according to an example of the present application. Referring to FIG. 6, at a hardware level, the first load balancer includes a processor, an internal bus, a network interface, an internal memory, and a non-volatile memory, and of course, may also include hardware required for other services. The processor reads corresponding computer program from the non-volatile memory into the internal memory and then the corresponding computer program runs on the internal memory. A load balancing apparatus is formed at a logical level. Of course, in addition to the software implementation manners, the present application does not exclude other implementation manners, such as the combination manner of logic apparatuses or software and hardware, etc. That is, an execution subject of the following processing flow is not limited to each logical module, and may be hardware or logic apparatus. The first load balancer is coupled to forwarding sides of a plurality of security forwarding devices.

Referring to FIG. 7, in a software implementation manner, the load balancing apparatus based on the first load balancer may include a first receiving module 701, a first processing module 702 and a first transmission module 703.

The first receiving module 701 is configured to receive a first access request packet form a client.

The first processing module 702 is configured to use a scheduling algorithm to select a target security forwarding device from the plurality of security forwarding devices; and when a destination IP address of the first access request packet is the same as an IP address of a load side of the target security forwarding device, rewrite a destination MAC address of the first access request packet with a MAC address of the load side of the target security forwarding device to generate a second access request packet.

The first transmission module 703 is configured to transmit the second access request packet to access to a server through the target security forwarding device.

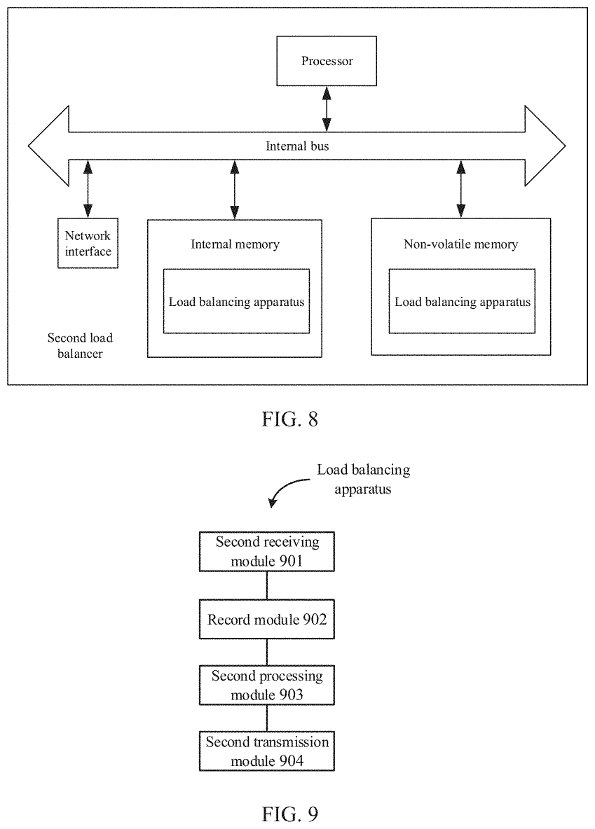

FIG. 8 is a schematic diagram illustrating a structure of a second load balancer according to an example of the present application. Referring to FIG. 8, at a hardware level, the second load balancer includes a processor, an internal bus, a network interface, an internal memory, and a non-volatile memory, and of course, may also include hardware required for other services. The processor reads corresponding computer program from the non-volatile memory into the internal memory and then the corresponding computer program runs on the internal memory. A load balancing apparatus is formed at a logical level. Of course, in addition to the software implementation manners, the present application does not exclude other implementation manners, such as the combination manner of logic apparatuses or software and hardware, etc. That is, an execution subject of the following processing flow is not limited to each logical module, and may be hardware or logic apparatuses.

Referring to FIG. 9, in a software implementation manner, the load balancing apparatus based on the second load balancer may include: a second receiving module 901, a record module 902, a second processing module 903 and a second transmission module 904.

The second receiving module 901 is configured to receive a third access request packet from a target security forwarding device.

The record module 902 is configured to record a MAC address of a forwarding side of the target security forwarding device in session information of an access session established with the server.

The second processing module 903 is configured to, when a third response packet corresponding to the third access request packet returned by the server is received, rewrite a destination MAC address of the third response packet with the MAC address recorded in the session information to acquire a fourth response packet.

The second transmission module 904 is configured to transmit the fourth response packet to respond to a client through the target security forwarding device.

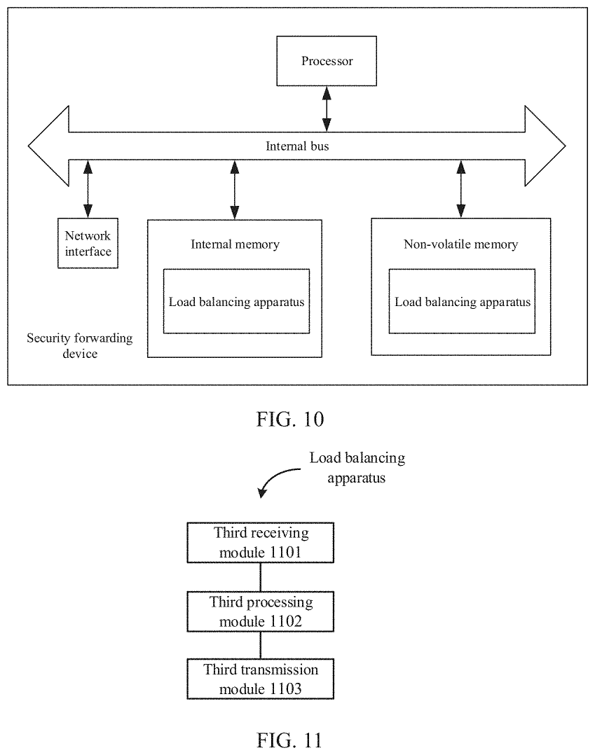

FIG. 10 is a schematic diagram illustrating a structure of a security forwarding device according to an example of the present application. Referring to FIG. 10, at a hardware level, the security forwarding device includes a processor, an internal bus, a network interface, an internal memory, and a non-volatile memory, and of course, may also include hardware required for other services. The processor reads corresponding computer program from the non-volatile memory into the internal memory and then the corresponding computer program runs on the internal memory. A load balancing apparatus is formed at a logical level. Of course, in addition to the software implementation manners, the present application does not exclude other implementation manners, such as the combination manner of logic apparatuses or software and hardware, etc. That is, an execution subject of the following processing flow is not limited to each logical module, and may be hardware or logic apparatus.

Referring to FIG. 11, in a software implementation manner, the load balancing apparatus based on the security forwarding device may include a third receiving module 1101, a third processing module 1102 and a third transmission module 1103.

The third receiving module 1101 is configured to receive a second access request packet from a first load balancer, where the second access request packet is generated by rewriting a destination MAC address of a first access request packet from a client with a MAC address of a load side of the target security forwarding device:

The third processing module 1102 is configured to construct a third access request packet according to the second access request packet, where a source IP address of the third access request packet is an IP address shared by the forwarding side of the target security forwarding device and the second load balancer, and a destination MAC address of the third access request packet is a MAC address of the server.

The third transmission module 1103 is configured to transmit the third access request packet to the second load balancer, so that the second load balancer transmits the third access request packet to the server.

In a typical configuration, a computing device, such as the first load balancer, the security forwarding device and the second load balancer, includes one or more processors (CPUs), input/output interfaces, network interfaces, a non-volatile memory and an internal memory.

For the apparatus examples, since they basically correspond to the method examples, reference may be made to the partial description of the method examples. The apparatus examples described above are merely illustrative, wherein the modules described as separate components may or may not be physically separated, and the components displayed as modules may or may not be physical modules, i.e., may be located in one place or may be distributed to multiple network modules. Some or all of the modules may be selected according to actual needs to achieve the objectives of the present application. Those of ordinary skill in the art can understand and implement the present application without any creative effort.

Although the present application contains many specific implementation details, these should not be construed as limiting the scope or the claimed scope of any invention, but rather are mainly used to describe the features of a specific embodiment of a particular invention. Some features described in many examples of the present application may also be implemented in combination in a single example. In another aspect, the various features described in a single example may also be implemented separately in many examples or in any suitable sub-combination. Moreover, although the features may function in certain combinations as described above and are even so initially claimed, one or more features from a claimed combination may be removed from the combination in some cases, and the claimed combination may refer to a sub-combination or a variant of the sub-combination.

The above are only the preferred examples of the present application, which are not intended to limit the present application, and any modifications, equivalent substitutions, improvements thereof, etc. made within the spirit and principles of the present application should be included in the protection scope of the present application.

What is claimed is:

1. A load balancing system, comprising:
a client;
a first load balancer coupled to the client;
a plurality of security forwarding devices whose load sides are coupled to the first load balancer and forwarding sides are coupled to a second load balancer;
the second load balancer; and
a server coupled with the second load balancer;
wherein the first load balancer is configured to:
receive a first access request packet from the client;
use a scheduling algorithm to select a target security forwarding device from the plurality of security forwarding devices;
when a destination IP address of the first access request packet is the same as an IP address of a load side of the target security forwarding device, rewrite a destination MAC address of the first access request packet with a MAC address of the load side of the target security forwarding device to generate a second access request packet; and
send the second access request packet to access to the server through the target security forwarding device.

2. The system according to claim 1, wherein the first load balancer is further configured to:
receive a first response packet returned by the server through the target security forwarding device;
rewrite a destination MAC address of the first response packet with a MAC address of the client to acquire a second response packet; and
transmit the second response packet to the client.

3. The system according to claim 1, wherein the target security forwarding device is configured to:
receive the the second access request packet; and
construct a third access request packet according to the second access request packet, wherein a source IP address of the third access request packet is an IP address of a forwarding side of the target security forwarding device, a destination MAC address of the third access request packet is a MAC address of the server;
transmitting the third access request packet to the second load balancer, so that the second load balancer transmits the third access request packet to the server.

4. The system according to claim 3, wherein the target security forwarding device is further configured to:
receive a fourth response packet from the second load balancer, wherein the fourth response packet is acquired by rewriting, by the second load balancer, a destination MAC address of a third response packet returned by the server with a MAC address of the forwarding side of the target security forwarding device, and the MAC address of the forwarding side of the target security forwarding device is recorded by the second load balancer in session information of an access session established between the second load balancer and the server after receiving the third access request packet; and
construct a first response packet, wherein a destination MAC address of the first response packet is a MAC address of the first load balancer; and
send the first response packet to the first load balancer, so that the first load balancer rewrites the destination MAC address of the first response packet with a MAC address of the client to generate a second response packet, and forwards the second response packet to the client.

5. The system according to claim 3, wherein the second load balancer is configured to:
forward the third access request packet from the target security forwarding device to the server;
record a MAC address of the forwarding side of the target security forwarding device in session information of an access session established with the server;
when a third response packet corresponding to the third access request packet returned by the server is received, rewrite a destination MAC address of the third response packet with the MAC address recorded in the session information to acquire a fourth response packet; and
transmitting the fourth response packet to the target security forwarding device.

6. The system according to claim 5, wherein the second load balancer is further configured to:
query whether there exists a conflicting packet of the third access request packet in the session information of the access session established with the server, wherein a source IP address, a source port number, a destination IP address, and a destination port number of the conflicting packet are consistent with those of the third access request packet; and
if there exists the conflicting packet of the third access request packet in the session information of the access session established with the server, perform NAT processing on a source port number of the third access request packet.

7. The system according to claim 1, wherein the IP address of the load side of the target security forwarding device is the same as a virtual IP address of the first load balancer; and
an IP address of the forwarding side of the target security forwarding device is the same as a virtual IP address of the second load balancer.

8. The system according to claim 1, wherein the first load balancer is further configured to use a scheduling algorithm and a used time length to select the target security forwarding device from the plurality of security forwarding devices.

9. A load balancing method applicable to a load balancer, comprising:
receiving a first access request packet from a client, wherein the load balancer is coupled to forwarding sides of a plurality of security forwarding devices;
using a scheduling algorithm to select a target security forwarding device from the plurality of security forwarding devices;
when a destination IP address of the first access request packet is the same as an IP address of a load side of the target security forwarding device, rewriting a destination MAC address of the first access request packet with a MAC address of the load side of the target security forwarding device to generate a second access request packet;
sending the second access request packet to access to a server through the target security forwarding device.

10. The method according to claim 9, wherein using the scheduling algorithm to select the target security forwarding device from the plurality of security forwarding devices comprises:
using the scheduling algorithm and a used time length to select the target security forwarding device from the plurality of security forwarding devices.

11. The method according to claim 9, wherein the IP address of the load side of the target security forwarding device is the same as a virtual IP address of the load balancer.

12. The method according to claim 9, further comprising:
receiving a first response packet returned by the server through the target security forwarding device;
rewriting a destination MAC address of the first response packet with a MAC address of the client to acquire a second response packet; and
transmitting the second response packet to the client.

13. A load balancing method applicable to a target security forwarding device, comprising:
receiving a second access request packet from a first load balancer, wherein the target security forwarding device is one of a plurality of security forwarding devices and selected by the first load balancer with a scheduling algorithm, the first load balancer is coupled to load sides of the plurality of security forwarding devices, and the second access request packet is generated by rewriting a destination MAC address of a first access request packet from a client with a MAC address of a load side of the target security forwarding device; and
constructing a third access request packet according to the second access request packet, wherein a source IP address of the third access request packet is an IP address of a forwarding side of the target security forwarding device, a destination MAC address of the third access request packet is a MAC address of the server;
transmitting the third access request packet to a second load balancer, so that the second load balancer transmits the third access request packet to the server, wherein the second load balancer is coupled to forwarding sides of the plurality of security forwarding devices.

14. The method according to claim 13, wherein the IP address of the load side of the target security forwarding device is the same as a virtual IP address of the first load balancer; and
an IP address of the forwarding side of the target security forwarding device is the same as a virtual IP address of the second load balancer.

15. The method according to claim 13, further comprising:
receiving a fourth response packet from the second load balancer, wherein the fourth response packet is acquired by rewriting, by the second load balancer, a destination MAC address of a third response packet returned by the server with a MAC address of the forwarding side of the target security forwarding device, and the MAC address of the forwarding side of the target security forwarding device is recorded by the second load balancer in session information of an access session established between the second load balancer and the server after receiving the third access request packet; and
constructing a first response packet, wherein a destination MAC address of the first response packet is a MAC address of the first load balancer; and
sending the first response packet to the first load balancer, so that the first load balancer rewrites the destination MAC address of the first response packet with a MAC address of the client to generate a second response packet, and forwards the second response packet to the client.
